(19) United States
(12) Patent Application Publication
(10) Pub. No.: US 2012/0085294 A1
(43) Pub. Date: Apr. 12, 2012

(54) Interactive Feline Toy

(75) Inventor: Tristan Christianson, San Francisco, CA (US)

(73) Assignee: ABSOLUTELYNEW, INC., San Francisco, CA (US)

(21) Appl. No.: 13/267,319

(22) Filed: Oct. 6, 2011

Related U.S. Application Data
(60) Provisional application No. 61/390,733, filed on Oct. 7, 2010.

(51) Int. Cl. A01K 29/00

(52) U.S. Cl. 119/707

(57) ABSTRACT

An interactive toy for use by domestic felines. The toy is comprised of an outer shell wrapped with material suitable for scratching, a removable attractant insert with a plaything attached to the lid, and an interior treat-containing cavity having a sidewall opening to restrictably release said treats. The toy combines the major activities and entertainment forms of a typical domestic cat into a one combined plaything.

### CROSS-REFERENCE TO RELATED APPLICATIONS: U.S. 61/390,733

### FEDERALLY SPONSORED RESEARCH: None

### SEQUENCE LISTING: None

### BACKGROUND OF THE INVENTION

Cats are well known domestic pets, and there are many pet toys available in the market with various different designs and purposes. Most of these toys can be categorized into the specific purpose to accommodate or encourage a specific cat behavior. For an example, cats are known to have a natural scratching urge, and therefore there are various products to provide cat owners an acceptable surface for their cats to scratch.

Another example of a specific cat behavior is predation. Cats are natural predators, and as such, need an outlet for their natural predator instincts. Therefore, another line of cat toys is designed to cater to this behavior by mimicking prey with items such as feathers or string. This category of toys will be referred to as playthings for the purpose of this application.

Yet another form of feline enjoyment can be found in attractants, such as catnip. Catnip is a plant used as a recreational substance for feline enjoyment. Catnip can be included in cat toy products to induce playful behavior, among other things. Finally, there are toys that can be filled with treats which can be consumed by the cat during play time.

While there are many forms and versions of cat toys available in the market, the present invention improves the design of cat toys by combining the different purposes of various cat toys into a single toy. This has the advantage of giving pet owners multiple forms of entertainment for their cats within a single toy, thus saving cost and storage space at home. The cat would also benefit from having different forms of play available from a single toy, allowing continuous entertainment for a longer period than a single-purposed toy.

### DRAWINGS

FIG. 1 shows an isometric view seen from above the toy;

FIG. 2 shows an isometric view seen from above the toy with the attractant dispenser and attached plaything cap removed from the main body;

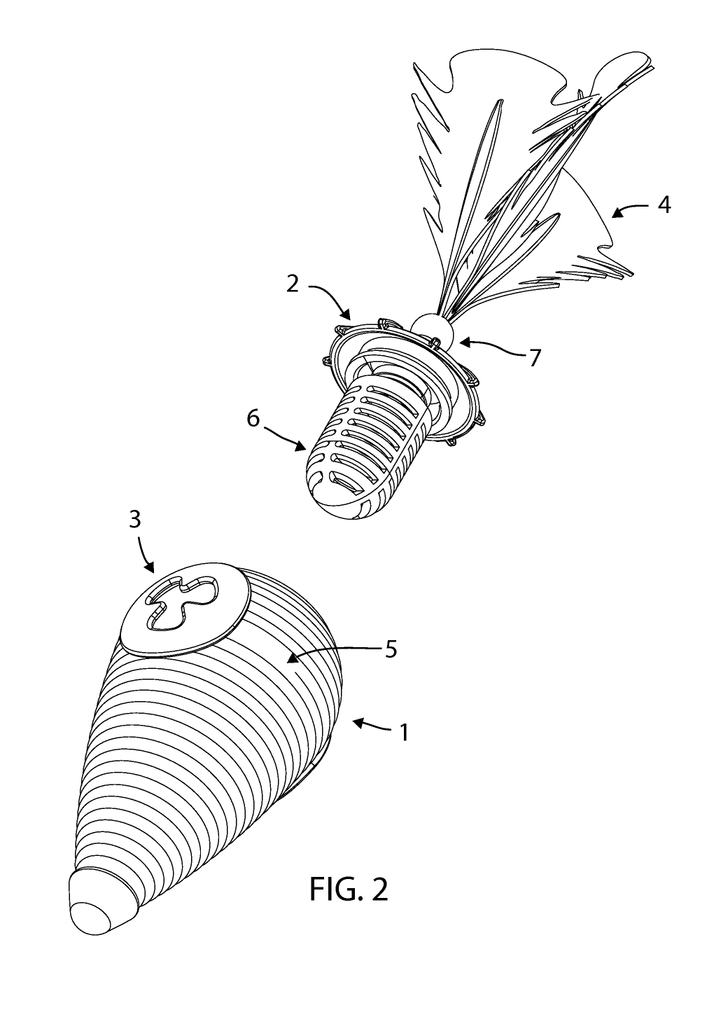

FIG. 3 shows an isometric view seen from above the toy of a variant design, further disassembling the attractant dispenser and the plaything cap away from the main body.

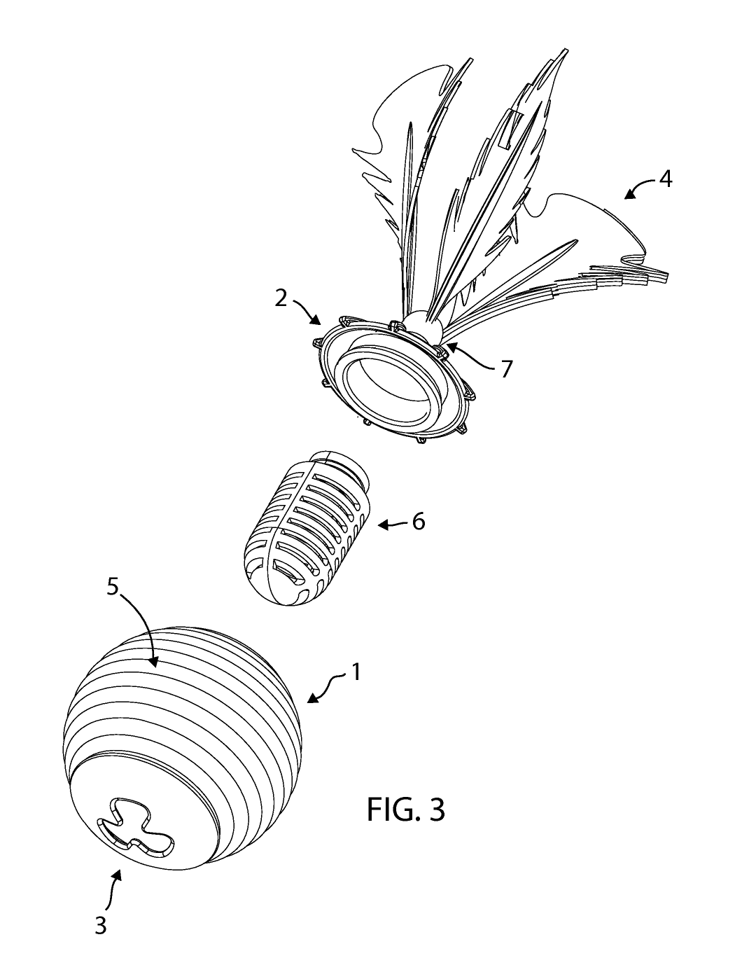

### DETAILED DESCRIPTION OF THE INVENTION

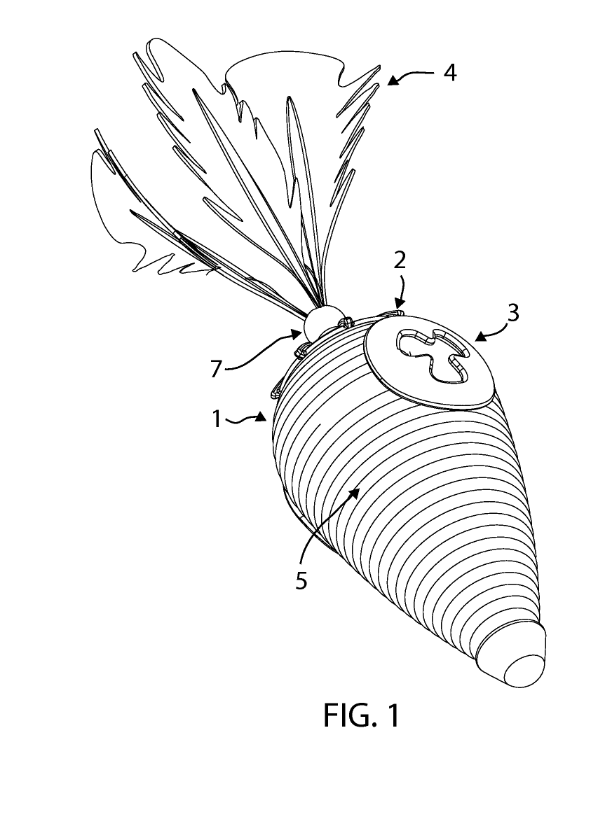

Looking at FIG. 1, the body 1 is depicted as a toy intended for use by domestic cats. The body 1 can be made to any shape desirable. However, the most ideal shape should be something spherical, conical or cylindrical to allow the toy to roll around when the cat plays with the toy. Notwithstanding the shape, body 1 is a hollow round like object made of a preferably hard material resembling a shell. In the preferred embodiment, body 1 is made of a plastic mold resembling a shell, but other alternative materials that can achieve the same result should be known to the person having ordinary skill in the art.

The toy is further provided with means to insert attractant materials into the container 6, made out of odor-permeable material such as mesh, such that the scent can permeate without spilling the attractant inside body 1. The container 6 can be detached from the lid 2, to which the plaything 4 is attached. The attractant can be catnip or any material that produces scent that can attract a cat. The plaything 4 can be anything that attracts and allows the cat to play predatory games, including but not limited to feathers, ropes and strings. The plaything base 7 is made of a flexible material that allows the plaything to bend to all directions with the purpose of extending the durability of the plaything 4 and prevent the plaything 4 from breaking loose during vigorous play.

The body 1 will also have at least one cavity sidewall opening 3 that allows treats to be released from the toy. Treats can easily be placed in the interior cavity by removing the lid 2 and the attached container 6. Lid 2 is attached and fastened to the toy 1 by any variety of methods, including but not limited to quarter turn locking mechanism.

The sidewall opening 3 is comprised of slits with a frictional material designed to prevent the treats from falling out too easily during play. The cat would then have to pick on the opening 3 using its mouth or claw in order to access the treats inside the toy. Alternatively, the user can also wedge treats in the slit, allowing the treat to be more prominent to the cat to further motivate a cat that is hesitant to play with the toy.

The surface of the toy can be layered with scratching material 5, allowing the cat to have a surface ready should it engage its scratching behavior during play time. The scratching material can be made of any material available in the market for scratching purposes, including sisal.

What is claimed is:

1. An interactive feline toy comprising:
a. A generally round shaped, hollow body, where the body is made of hard materials to resemble a shell;
b. A lid to access the inner space of the body, where said lid further comprises of said permeable container for a replaceable supply of catnip, said container being removably attached to the inner side of the lid;
c. Said body further comprises of a layer of scratchable material layered on the external surface of the body;
d. Said body further comprises of a plurality of openings to access the food placed inside said body;
e. A plaything, having attached to the external portion of said lid, where said plaything further comprises of a base made of flexible material attached to the lid.

2. An interactive feline toy in claim 1, where said permeable container is made from mesh.

3. An interactive feline toy in claim 1, where said lid is removably attached to the body.

4. An interactive feline toy in claim 1, where the scratching material is made of sisal.

5. An interactive feline toy in claim 1, where said openings are further comprised of slits made of frictional material.

6. An interactive feline toy in claim 1, where the plaything is attached to said lid using flexible materials.

7. An interactive feline toy in claim 1, where the plaything is made of feathers.

8. An interactive feline toy in claim 1, where the plaything is further comprised of a string attachment.

9. An interactive feline toy in claim 1, where the plaything is further comprised of a rope attachment.
